(19) United States
(12) Patent Application Publication
(10) Pub. No.: US 2010/0114905 A1
(43) Pub. Date: May 6, 2010

(54) Method, System, and Product for Managing Spatial Data in a Database

(76) Inventors: Elvin Slavik, Melbourne (AU); Stephen Quan, Melbourne (AU)

Correspondence Address: LAW OFFICE OF BRUCE D. LATHROP, 174 W. Foothill Blvd., #317, Monrovia, CA, 91016, US

(21) Appl. No.: 12/606,514

(22) Filed: Oct. 27, 2009

Related U.S. Application Data
(60) Provisional application No. 61/110,799, filed on Nov. 3, 2008.

(51) Int. Cl. G06F 17/30

(52) U.S. Cl. 707/743; 707/E17.11

(57) ABSTRACT

A method, spatial data system, and computer program product for managing spatial data stored in a database by indexing spatial object identifiers associated with spatial objects of varying dimensions using a spatial index for each spatial object identifier comprised of one or more index coordinate variables that define a single point spatially related to the spatial object and one or more index dimension variables that define a bounding shape based on the spatial object's size. The spatial data system is configured to allow querying of the database to determine spatial object identifiers, and associated spatial objects, within a search area by identifying spatial indexes that define bounding shapes intersecting the search area and producing the results on a user interface.

This application claims the priority to U.S. provisional patent application Ser. No. 61/110,799, entitled SPATIAL KEY INDEXING, filed on Nov. 3, 2008.

### TECHNICAL FIELD

The described technology relates to a method, system, and computer program product for managing spatial data stored in a data processing system (collectively referred to herein as “the spatial data system”), that requires less data storage and less data processing power.

### BACKGROUND

The purpose of including spatial data in a database is to be able to query the database for information about geometric objects (e.g., architectural features, product design components, homes, parks, streets, etc.) (referred to herein as “spatial objects”) represented in the database with spatial object identifiers. The query may also be further refined to include additional conditional clauses based on non-spatial attributes within the database (such as materials, function, price, hours, and addresses). Indexing improves database performance speed, including the speed of interrogating spatial databases to identify valid data within a fixed geographic area, for example, for display on a computer screen. Typical application purposes for spatial indexing are very broad, including and not limited to power plant management, timber resource management, and geographic information system applications such as high-speed map visualization, navigation systems, and location based services.

Almost all computing platforms today have support for relational database management systems or RDBMS technology. A RDBMS is a database management system (DBMS) that uses relational techniques for storing and retrieving data. A RDBMS includes the ability to store and index simple data (numbers and text). Typically, RDBMS indexing technology uses B-Tree, Hash tables, and other similar techniques, which are well suited for single dimensional data types such as numbers and text, but not readily applicable for spatial data. Very few databases have support for spatial indexing or the ability to extend the RDBMS to support spatial indexing. Those that do, have complex spatial data structures that require substantial computer processing power.

An example of such complex spatial data structures is the use of one or more levels of grids with pre-determined cell sizes. Spatial object identifiers are indexed according to the cells in the grid within which they fall, either completely or partially. The larger the pre-determined grid cell size, the fewer number of cells to which a spatial object identifier is indexed. Correspondingly, if the predetermined cell size is decreased, the same spatial object identifier will be indexed to a larger number of cells.

In such grid data structures, the storage and processing requirements for the database system increase with the number of grid cells that overlap a spatial object. This aspect would suggest large grid cell sizes compared to spatial object sizes in order to approach a one-to-one relationship of index entries to spatial object identifiers. Because typical spatial queries are based on finding spatial objects that overlap a rectangular query search area, the grid index technique will scan all index entries in the grid cells that overlap the query search area. However, as the grid size increases, more index entries outside the query search area will need to be examined and discarded. Therefore, for a system using the grid system to be efficient, an optimal grid size must be determined through an appropriate trade-off between these two opposing considerations.

However, unless the spatial objects included in the database are of near uniform dimension, even the most optimized grid cell size will result in cells that are either too large or too small for spatial objects included in the database. This creates a need for increased processing speed, storage requirements, and complex data management software tools and applications as spatial datasets grow in size and popularity. This problem requires desktop systems and servers of increasing power and, conversely, limits the usefulness of spatial data in a wide variety of less powerful devices such as portable computers, PDAs, and mobile phones.

### SUMMARY

The spatial data system solves this problem of indexing spatial objects of varying dimensions by using a spatial index that does not depend on use of one or more grids of predetermined cell sizes. Instead, the spatial index for each spatial object identifier is comprised of one or more index coordinate variables that define a single point and one or more index dimension variables that define a single length or spatial object size. Each index coordinate variable corresponds, for example, to the lowest variable value for the spatial object in a predefined coordinate system, for example Xₘᵢₙ and Yₘᵢₙ for a spatial object in a Cartesian coordinate system. The one or more index dimension variables define a spatial object's size or the largest dimension of said spatial object. In one embodiment of the spatial data system, this is accomplished using vectors of a magnitude equal to the largest dimension of a spatial object. In another embodiment, this is accomplished using a calculation based on the determination of the greatest difference between the smallest and largest coordinate variable values for the spatial object in a predefined coordinate system, for example the greater of Xₘₐₓ−Xₘᵢₙ or Yₘₐₓ−Yₘᵢₙ in a Cartesian coordinate system.

In another embodiment of the spatial data system, spatial object identifiers are assigned index dimension variables based on defined relationships between index dimension variables and spatial object dimension size range identifiers.

In another embodiment, index coordinate variables taken together can be used to define a point on or within a pre-defined bounding shape, for example, Xₘᵢₙ and Yₘᵢₙ on a square situated with sides parallel to the coordinate axes, or the center coordinates of a circle. Each of said spatial objects can then be enclosed by said pre-defined bounding shape by proportionally re-sizing said pre-defined bounding shape according to the index dimension variables.

Alternatively, the spatial data system can include a spatial index corresponding to additional bounding shapes to be selected from a plurality of pre-defined bounding shapes, such as a circle, triangle, sphere, and cone, for example, by including offsets from index coordinate variables, such as radii values.

In one embodiment, the index dimension variables can define one or more pre-defined arcs or line segments to define the bounding shape's size and all or part of its shape.

In another embodiment, the spatial data system can define a spatial index for multi-dimensional spatial objects, wherein such spatial objects have three or more dimensions. Still another embodiment can define a spatial index where one or all the dimensions of the spatial object define characteristics other than distance, such as elapsed time, temperature range, radiation gradient, or coefficients of friction.

In another embodiment, said index dimension variables are defined by a scalar value function, or “Q” function, of said largest dimension of the spatial object. For example, Q may define a value that is the next largest integer above the largest dimension. In another embodiment, Q may be the natural log of the largest dimension or may be the product of said log and a pre-defined scaling factor such as the number ten. In a preferred embodiment, Q is equal to the natural log of the largest dimension, multiplied by a pre-determined scaling factor, with the product rounded up to the nearest integer. The Q function may be advantageously selected to optimize the number of bounding shape dimensions to provide the best match for the database size or content, or system performance given the processing power or storage capacity available for a particular computing platform.

Another aspect of the spatial data system is that the spatial index can be defined using spatial properties available for any spatial object, for example, the spatial bounds (X_{MIN}, Y_{MIN}, X_{MAX}, and Y_{MAX}). The index dimension variables and each of the spatial boundary values can be stored in a column associated with each spatial object identifier row or record in a database, for example, as illustrated in the following table where the index dimension variables are defined by a scalar value function “Q.”

| Object | Q | X_{MIN} | Y_{MIN} | X_{MAX} | Y_{MAX} |
|---|---|---|---|---|---|
| Object1 | | | | | |
| Object2 | | | | | |
| Object . . . | | | | | |
| ObjectN | | | | | |

The spatial data system has a number of advantages over a grid-based system with predetermined cell sizes. The spatial data system allows indexing a spatial object identifier so that it may be subjected to a search area query using less processing power because the spatial data system simplifies the spatial data structure. For example, in the preceding Q function embodiment, the resulting spatial index is comprised of numeric values. Such numeric values are well suited for databases, including RDBMS. Querying and retrieval of spatial index values matching a search area can be performed using the in-built query processors available in most RDBMS or relatively simple techniques of index traversal. Associated spatial object values can be determined using the spatial index value results.

Another advantage of the spatial data system is that its spatial data structure does not require use of specialized schema tables to manage the index.

Another advantage of the spatial data system it that the spatial data structure is suitable for a wide range of spatial data, but is modifiable as needed for specific data purposes. For example if there is an unusual spatial domain to the data.

Another advantage of the spatial data system over the prior art is that applying the principles of the invention results in the need for minimal application logic in creating spatial queries. Another advantage is that the indexing method is dynamic and self-tuning to the spatial data.

Another advantage of the spatial data system is that it allows similar sized data to be grouped within the database based on the index dimension variables. Such groupings allow for more efficient testing of spatial data, for example by using such index dimension variables to more easily match database records to the area to be displayed on a computer screen.

Another advantage of the spatial data system is that it is scalable to multiple processors, distributed processing, and cloud computing because the index dimension variables can be used to partition data to run on multi-core processors or spread over multiple servers and other networked computing devices.

Another advantage of the spatial data system is that it can be implemented on flat files on top of simple indexing technology, such as B-tree indexing technology, that does not have RDBMS functionality. Accordingly, the spatial data system can be in a computing environment where RDBMS are not available, such as embedded devices like mobile phones, wherein the spatial data system can be implemented in a variety of file formats, including using basic B-tree parameters, that support the spatial index of the spatial data system.

Another advantage of the spatial data system is that it works on points, lines, and polygons and can index a single table containing all geometry types without loss of performance. Applications in the prior art, require points, lines and polygons to be stored in separate tables and each separately tuned with different index grid(s). Other prior art applications require multi-table or layered data. A variety of embodiments configured in accordance with the invention allow the optional storage of points, lines, and polygons in a single table. The spatial data system can advantageously index multi-layered data and maintain high performance for a mixed variety of spatial data types.

The spatial data system described herein could be modified and applied to a very wide range of computing and database platforms with minimal specific adaptation to the platforms. This creates a significant additional advantage for the spatial data system because it can be used for spatial data on platforms previously considered unsuitable, especially for very large datasets.

One application of the spatial data system is to Microsoft SQL Server and Oracle database applications.

### BRIEF DESCRIPTION OF THE DRAWINGS

FIG. 1 depicts application of an embodiment of the spatial data system on spatial objects.

FIG. 2A depicts application of an embodiment configured to display on a user interface the spatial object Australia with an area scale just large enough to include the entire continent.

FIG. 2B depicts the spatial object Australia and its spatial object sub-areas using an index table embodiment.

FIG. 3 depicts an embodiment of the spatial data system adapted to retrieve spatial object identifier data, which is stored in a database, in which the spatial object identifier data is related to the user interface of FIG. 2A.

FIG. 4 depicts a bounding shape defined in an embodiment using vectors of a magnitude equal to the largest dimension of a spatial object.

FIG. 5 depicts predefined bounding shapes proportionately re-sized in an embodiment as a function of a spatial object's index dimension variables.

FIG. 6 depicts look-up tables in an embodiment for allocation of data processing or memory storage within the spatial data system as a function of the index dimension variables.

FIG. 7 depicts a multi-dimensional spatial object where one dimension is elapsed time.

FIG. 8 depicts operations of the spatial data system of FIG. 3 for determining Q values using a scalar value function.

FIG. 9 depicts a first set of suboperations for the operations of FIG. 8.

FIG. 10 depicts a second set of suboperations for an operation of FIG. 8.

FIG. 11 depicts a third set of suboperations for an operation of FIG. 8.

FIG. 12 depicts a first operation of the spatial data system of FIG. 3 for searching spatial object identifiers with Q values determined using a scalar value function.

FIG. 13 depicts a second operation of the spatial data system of FIG. 3 for searching spatial object identifiers with Q values determined using a scalar value function.

FIG. 14 depicts a third operation of the spatial data system of FIG. 3 for searching spatial object identifiers with Q values determined using a scalar value function.

FIG. 15 depicts an initial and expanded search rectangle derived through operation of the spatial data system of FIG. 3.

### DETAILED DESCRIPTION OF THE EMBODIMENTS

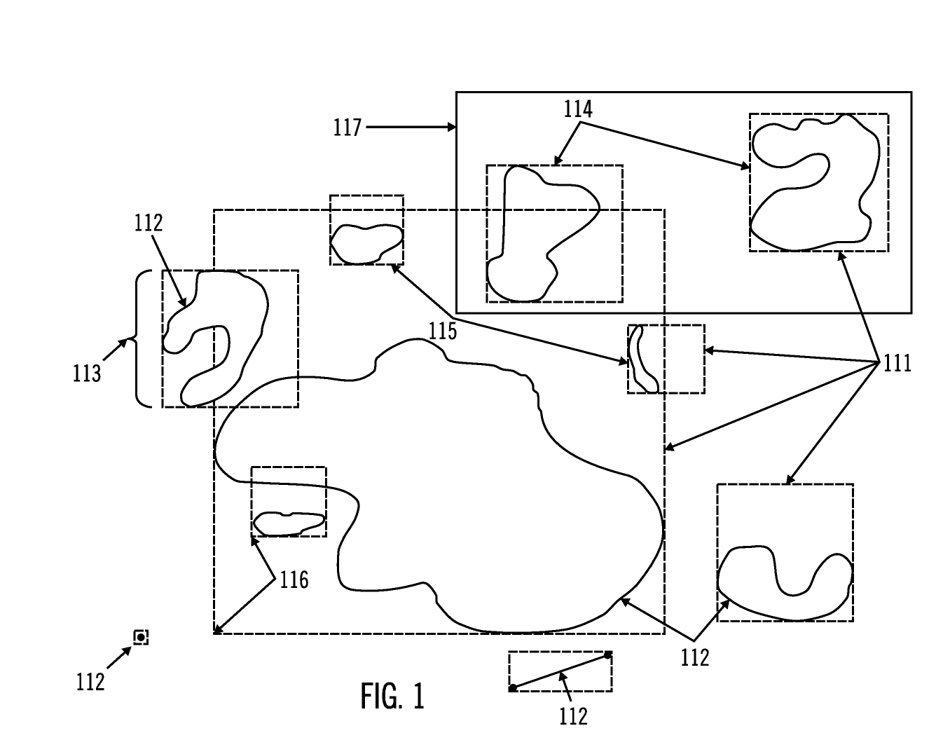

FIG. 1 depicts application of a preferred embodiment of the spatial data system on spatial objects 112, including points, lines, and polygons. Each spatial object 112 sets its own bounding shape 111 based on the size of the spatial object 112, so there is only one spatial index entry per spatial object identifier. The largest dimension 113 of the spatial object 112 determines the size of the bounding shape 111. Bounding shapes of similar sizes can be grouped according to their index dimension variables. For example, boxes of one size 114 can form one group and boxes of another size 115 can form another group. The index coordinate variables for each spatial object identifier define a single point (e.g., the extreme lower left corner 116 of the bounding shape 111). The spatial object identifier can then be indexed in the database as a function of its largest dimension and the index coordinate variables. This provides flexible spatial object data extents and avoids the requirement to pre-calculate or otherwise determine data extents to estimate the optimum grid cell size parameters. New spatial objects can be added to the database without affecting spatial index calculations. The spatial data system can then be used to query the search area 117 for spatial index values and associated spatial object identifiers that have bounding boxes intersecting the search area 117.

FIG. 1 depicts boxes 114 and 115 with similar dimensions. These boxes can be further grouped in the database based on their similar dimensions allowing for more efficient testing of spatial data, for example, by using such groupings to more easily match database records to the area to be displayed on a computer screen (not illustrated). For instance, if search results from search area 117 fall primarily within the grouping of 1× sized bounding shapes, the initial display area for the search results could have a 2× dimension.

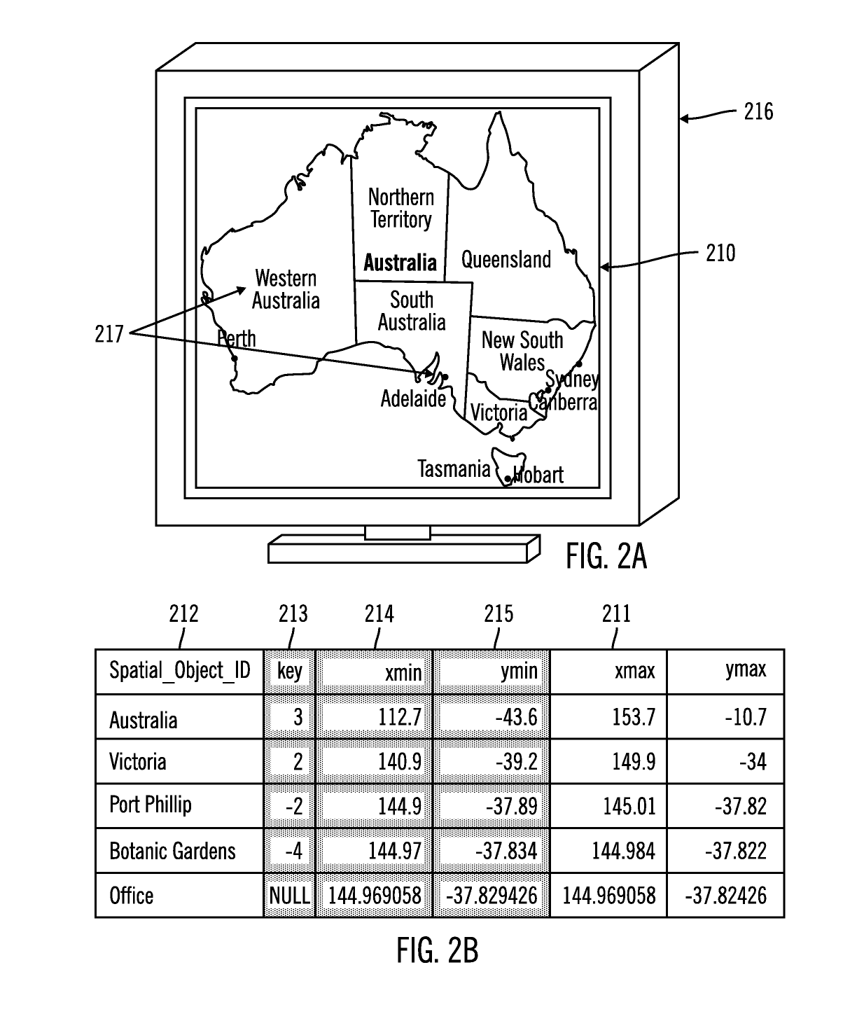

FIG. 2A depicts application of another embodiment configured to display on a user interface 216 (a display monitor) the spatial object Australia 210 with an area scale just large enough to include the entire continent, and its spatial object sub-areas 217 using an index table embodiment 211, depicted in FIG. 2B, in accordance with one aspect of the invention. Australia 210 and its sub-areas 217 are listed as records in the first column 212 of table 211. In this embodiment, the index dimension variables are listed in the second column 213 and the index coordinate variables are listed in the third and fourth columns 214 and 215. The index dimension variables 213 in this embodiment are determined in accordance with one aspect of the invention, which determination results in a large range of spatial object dimensions being grouped into a narrow range of single integer index dimension variables.

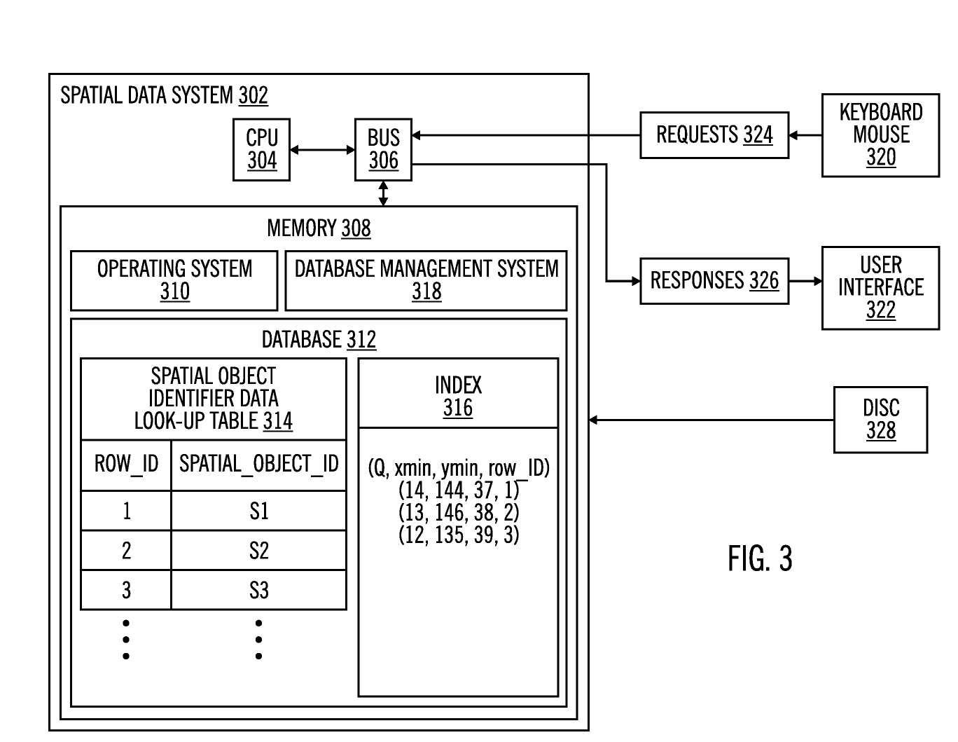

FIG. 3 shows one embodiment of the spatial data system 302, including a database management system 318 adapted to manage spatial object identifier data stored in a database 312, in which the spatial object data is displayed or presented in the user interface 322. The spatial data system 302 can also be called a data processing system.

The spatial data system 302 includes a central processing unit (CPU) 304, computer usable memory 308, and a bus 306 which operatively interconnects the CPU 304 and the memory 308. Also operatively connected to the bus 306 of the spatial data system 302 are user peripheral devices 320 (keyboard) and user interface 322 for handling user input/output (I/O) as known to those skilled in the art. For the purpose of explaining the embodiment, a single computing device will be described. However, it will be appreciated that the database management system 318 may be adapted to operate with a plurality of networked computing devices collectively or individually containing multiple processors, such as mobile devices, embedded devices, desktop devices, servers, or mainframe computers (not illustrated) and that portions of the database management system 318 may be relocated into the memories of the plurality of such devices. Memory 308 may include a combination of computer usable memory devices, such as RAM, ROM, hard disk, etc.

Stored in memory 308 is the database 312 containing spatial object identifier data in a table 314 and containing an index of spatial indexes 316 of the table 314. The memory 308 also contains an operating system (OS) 310, which are known to those skilled in the art. OS 310 handles general purpose tasks as known in the art, such as transferring data over the bus 306. Also stored in memory 308 is the database management system 318. The database management system 318 includes computer usable instructions (also referred to herein as “executable code”) that are used to instruct or direct the CPU 304 to respond to specific user requests 324, sent by a user via input user interface devices 320 (e.g., keyboard and/or mouse), and received by the CPU 304 over the bus 306. The computer usable instructions may be compiled from computer programmed instructions written in a high-level computer programming language using compilers known to those skilled in the art. The database management system 318 also provides responses 326 (via bus 306 to user interface 322) to requests 324.

Disc 328 is a computer program product including a computer readable medium tangibly embodying computer usable instructions for implementing the database management system 318 by moving the computer usable instructions stored in the disc 328 through a disc drive device (not illustrated) and continuing via the bus 306 and into storage in memory 308 and later executed by the CPU 304. It will be appreciated that an equivalent to the disc 328 is usage of a network operatively linked, in the manner known to those skilled in the art, to the spatial data system 302, and then the computer usable instructions of disc 328 may be downloaded to the memory 308 via the network (not illustrated).

The table 314 includes two columns in which the first column contains row_IDs (each row_ID is a unique identifier identifying a respective row of the table 314), and the second column contains the spatial object identifier, spatial_object_ID. It will be appreciated that an identifier is any entity that is used to identify another entity. They may include numbers, letters, words, symbols, markings, etc. The rows contained in the table 314 pair up a specific spatial object identifier with a unique row_ID. The manner in which the table 314 is populated with spatial object data is known to those skilled in the art.

The index of spatial indexes 316 may assume any form. It will be appreciated that the index 316 may be, for example, a B-tree index, a hash index, or a common delineated index, and it is expected that persons skilled in the art would know how to adapt specific indices to implement index 316. The index 316 in one embodiment contains a set of tuples (Q, XMIN, YMIN, row_ID). The first three values of each tuple include data for the bounding shape (for example as depicted in FIG. 1). The fourth value of each tuple includes data for a row_ID (that is, an identifier for a specific row of table 314).

The manner in which the values for the spatial indexes stored in the index 316 are determined and the database searched by querying the search area 117 of FIG. 1 are described below with reference to embodiments of the computer usable instructions written in SQL programming language and as diagrammed operations.

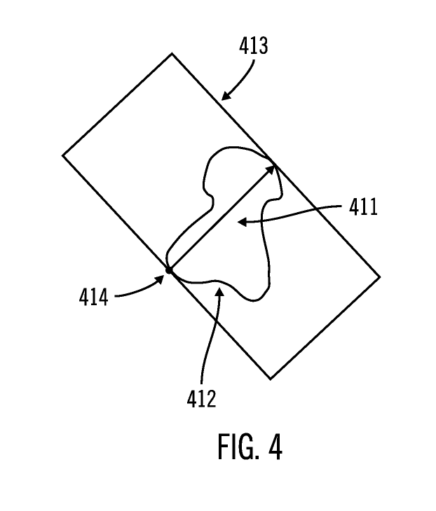

FIG. 4 shows an embodiment that includes a bounding shape defined by index dimension variables determined from a vector 411 with a magnitude equal to the largest dimension of the spatial object 412. Parallel and perpendicular vectors of the same magnitude define the bounding shape 413 for the spatial object 412 relative to the single point 414 defined by the index coordinate variables.

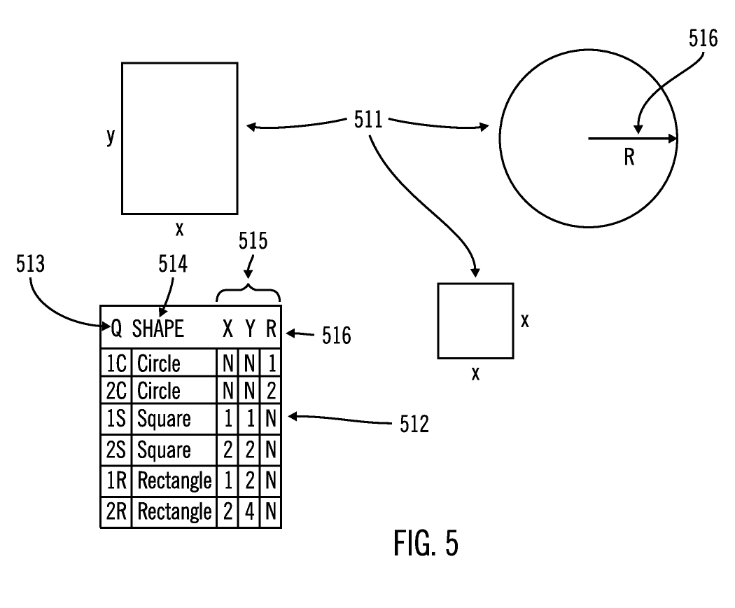

FIG. 5 shows an embodiment with predefined bounding shapes 511 that can be proportionately re-sized as a function of a spatial object's index dimension variables through a look-up table 512. The index dimension variables are used to define a spatial index value “Q” 513 that defines the resizing multiple, the predefined bounding shape type 514, and the dimension to be re-sized 515, including, for circular bounding shapes, a radius value 516.

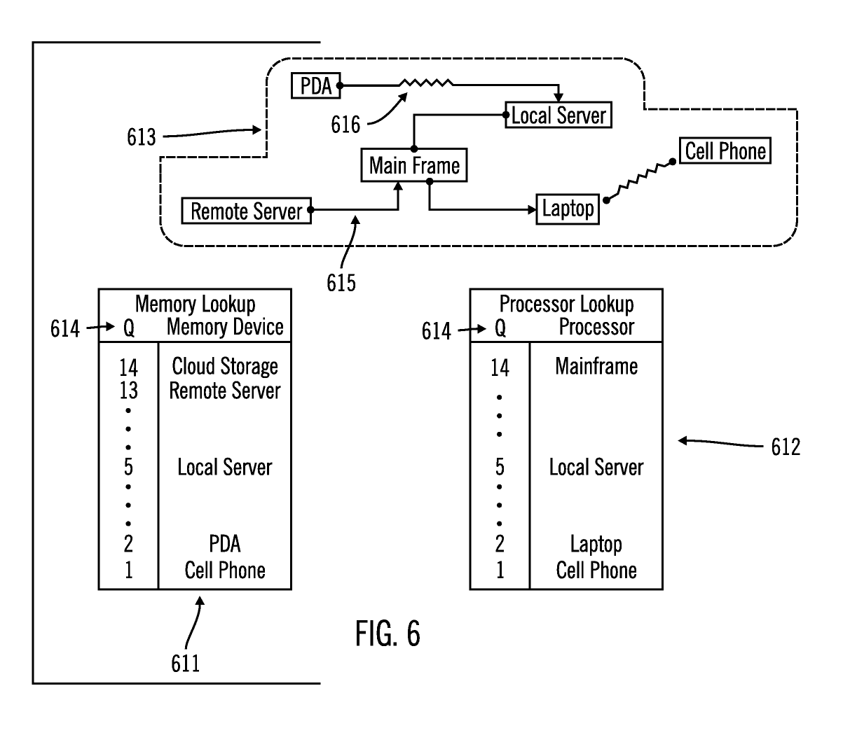

FIG. 6 shows an embodiment of the spatial data system that includes look-up tables 611 and 612 for allocation of data processing or memory storage within the spatial data system 613 as a Q function 614 of the index dimension variables. The spatial data system, in this embodiment, is in a networked configuration with wired 615 and wireless 616 operational interconnections.

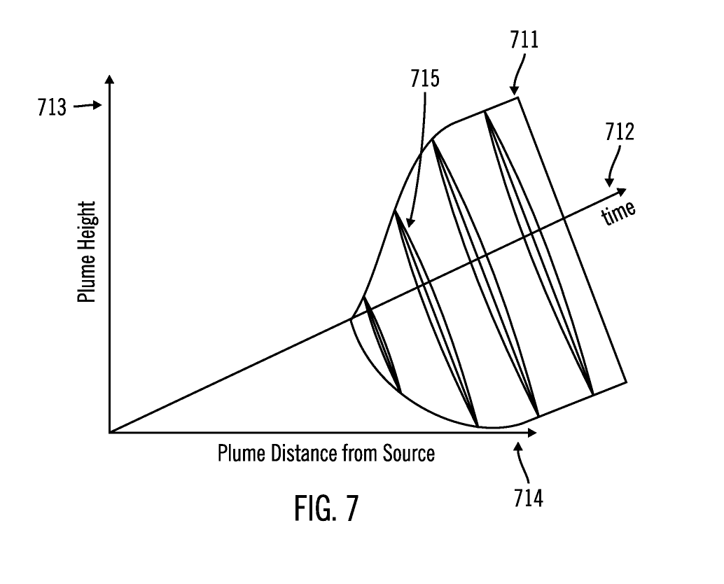

FIG. 7 shows a multi-dimensional spatial object 711 where one dimension is elapsed time 712 and the other dimensions define a gas plume height and distance from source axes 713 and 714, respectively, over time, creating additional two-dimensional spatial objects 715 that could be separately stored and indexed using one embodiment of the spatial data system.

A typical SQL statement to create a spatial table with the required columns for indexing in a preferred embodiment may appear as:

CREATE <datatable>

| ( | |
|---|---|
| <datacolumn1>, | |
| <datacolumn2>, | |
| <datacolumn3>, | |
| ... | |
| ... | |
| <datacolumnn>, | |
| Q | int, |
| XMIN | float, |
| YMIN | float, |
| XMAX | float, |
| YMAX | float |

);

Where “Q” is a function of the index dimension variables. The spatial extent columns (XMIN, YMIN, XMAX, and YMAX) define spatial objects listed in corresponding columns. These spatial objects may include a variety of spatial data types such as points, lines, and polygons. Various conventional database indices are then created on combinations of Q and the spatial extent columns.

The combinations actually used may vary from database to database depending on the design and efficiency of the query processing in the database.

Examples of commonly created indices using SQL and the Q function value are:

CREATE INDEX <spatialKeyIndexname> ON<datatable> (Q, XMIN, YMIN);
CREATE INDEX <xminIndexname> ON<datatable> (XMIN);
CREATE INDEX <yminIndexname> ON<datatable> (YMIN);
CREATE INDEX <xmaxIndexname> ON<datatable> (XMAX);
CREATE INDEX <ymaxIndexname> ON<datatable> (YMAX);

The above set of indices has been found to suit common query processors, such as that of Microsoft's SQL Server. In accordance with the invention, it is possible to study the query processor design and efficiency specific to a particular RDBMS in order to further tune and decide if further or fewer indices are desired to achieve maximum query processor efficiency.

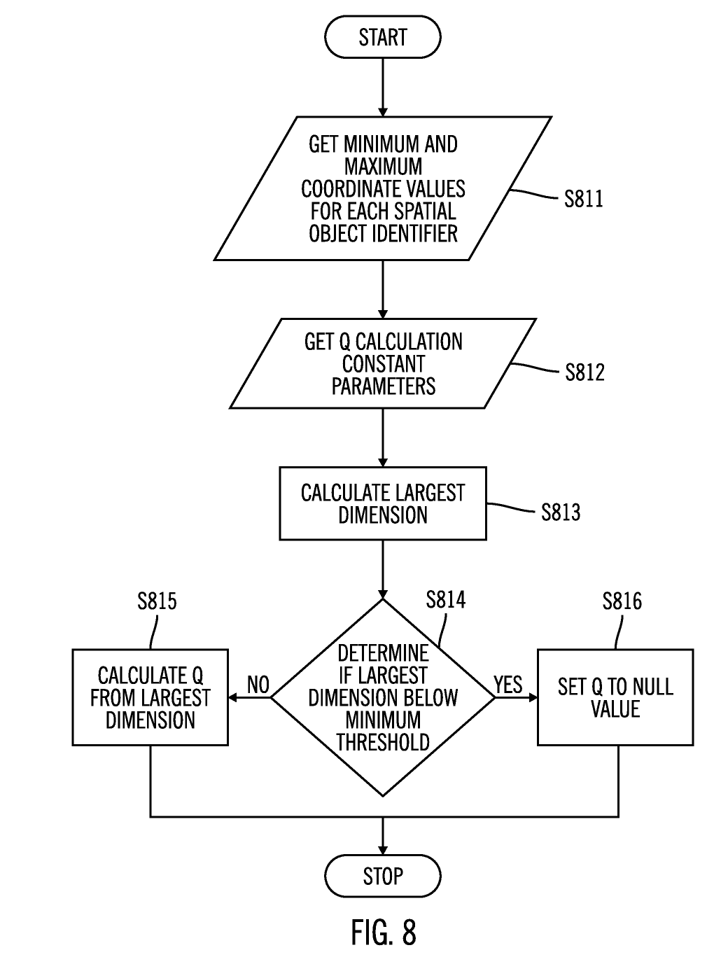

FIG. 8 shows operations of a preferred embodiment for calculating the Q function as a scalar value function. Operation S811 includes executable code for directing the CPU 304 to determine the minimum and maximum coordinate variables associated with each spatial object identifier. Operation S812 includes executable code for directing the CPU 304 to set predetermined values for minimum threshold, scaling factor, and offset parameters of the Q function (the purpose of each parameter in this preferred embodiment is described below). Operation S813 includes executable code for directing the CPU 304 to calculate the largest dimension associated with the spatial object identifier. Operation S814 includes executable code for directing the CPU 304 to determine if the largest dimension is greater than the minimum threshold for spatial object size (below this threshold, the spatial object is considered a point, as opposed to a line or polygon). If the largest dimension is greater than or equal to the threshold value, operation transfers to operation S815 which includes executable code for directing the CPU 304 to calculate Q as a scalar value function. If the largest dimension is less than the threshold value, operation transfers to operation S816 which includes executable code for directing the CPU 304 to set the Q function to “null.”

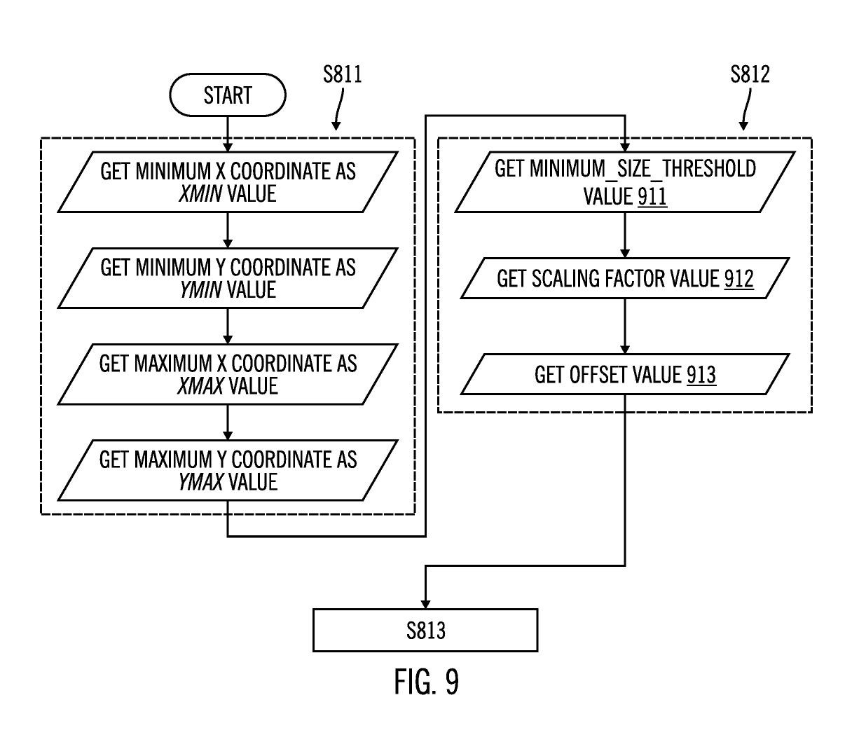

FIG. 9 shows suboperations for operation S811 and S812 for an embodiment suitable for two dimensional spatial objects.

In accordance with the invention, it is possible to use alternative values for the minimum size threshold 911 (e.g., 0.000001) and the scaling factor 912 (e.g., 1.0) for the purpose of tuning, and alternative values for offset value 913, for example to store the value Q in something smaller than an integer, such as an unsigned byte. In one embodiment, the offset value is set to zero where no offset value is provided.

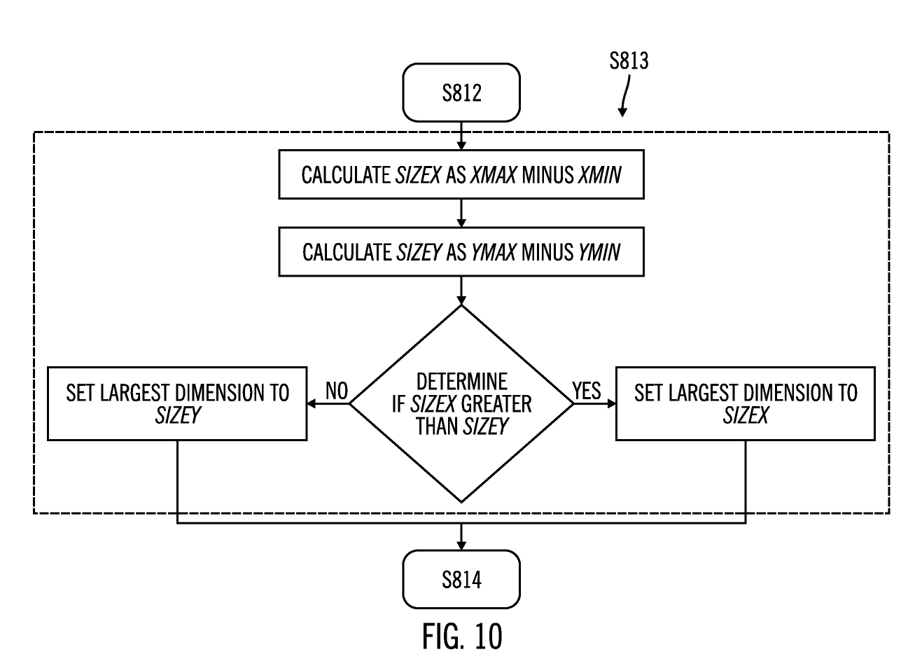

FIG. 10 shows suboperations for the operation S813 for an embodiment suitable for processing two dimensional spatial objects.

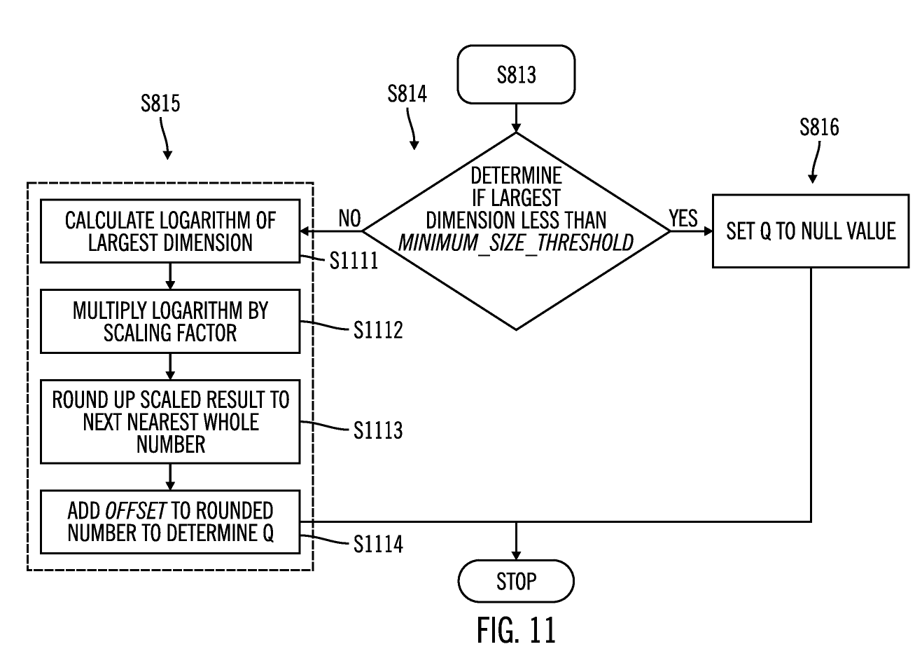

FIG. 11 shows corresponding suboperations for operation S815 for an embodiment where the Q value is a function of the logarithm of the largest dimension S1111, scaled by the scaling factor S1112, rounded to the next nearest whole number S1113, and offset according to the offset value S1114.

In another embodiment of the spatial data system, spatial object identifiers are assigned index dimension variables based on defined relationships between index dimension variables and spatial object dimension size range identifiers. In a preferred embodiment of this aspect of the invention, the index dimension variable, Q, is chosen from a look up table based on the dimensions of the spatial objects, as illustrated in the following SQL code:

CREATE TABLE <qTable>
(

| | |
|---|---|
| Q | int, |

XSIZE_MIN float,
XSIZE_MAX float,
YSIZE_MIN float,
YSIZE_MAX float

);
CREATE FUNCTION LookupQ
(

@xMin float,
@yMin float,
@xMax float,
@yMax float)

RETURNS int
AS
BEGIN

DECLARE @q int
DECLARE @dx float
DECLARE @dy float
SET @dx = @xMax − @xMin
SET @dy = @yMax − @yMin
SET @q = (SELECT Q from <qTable> WHERE @dx
BETWEEN XSIZE_MIN AND

XSIZE_MAX AND @dy BETWEEN YSIZE_MIN AND
YSIZE_MAX))

RETURN @q

END

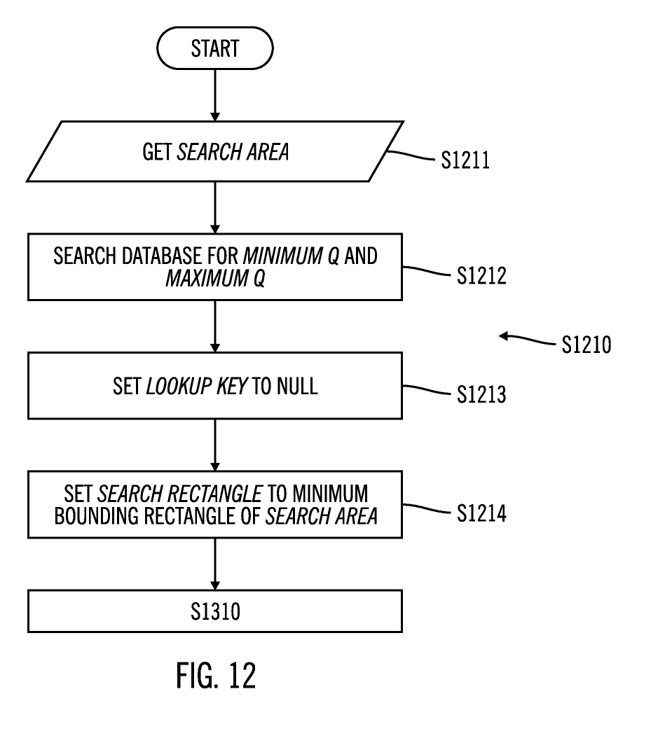

In accordance with a preferred embodiment, FIGS. 12, 13, and 14 show operations suitable for searching for spatial objects when the Q function is a scalar value function. Operation S1210, depicted in FIG. 12, includes executable code for directing CPU 304 to perform operations initiating the search. Operation S1211 sets the search area values. The search area can define a variety of shapes, including a rectangular shape or a shape of arbitrary dimensions selected by user requests 324.

Operation S1212 searches the database 312 for the maximum and minimum Q values within the search area. This search is an example of the auto-tuning aspect of the spatial data system because it serves to reduce the processing required to complete the search in cases when the overall range of Q values are limited.

Operation S1213 and S1214, respectively, set an initial lookup key value for Q at null and search rectangle dimensions as the minimum bounding rectangle for the search area.

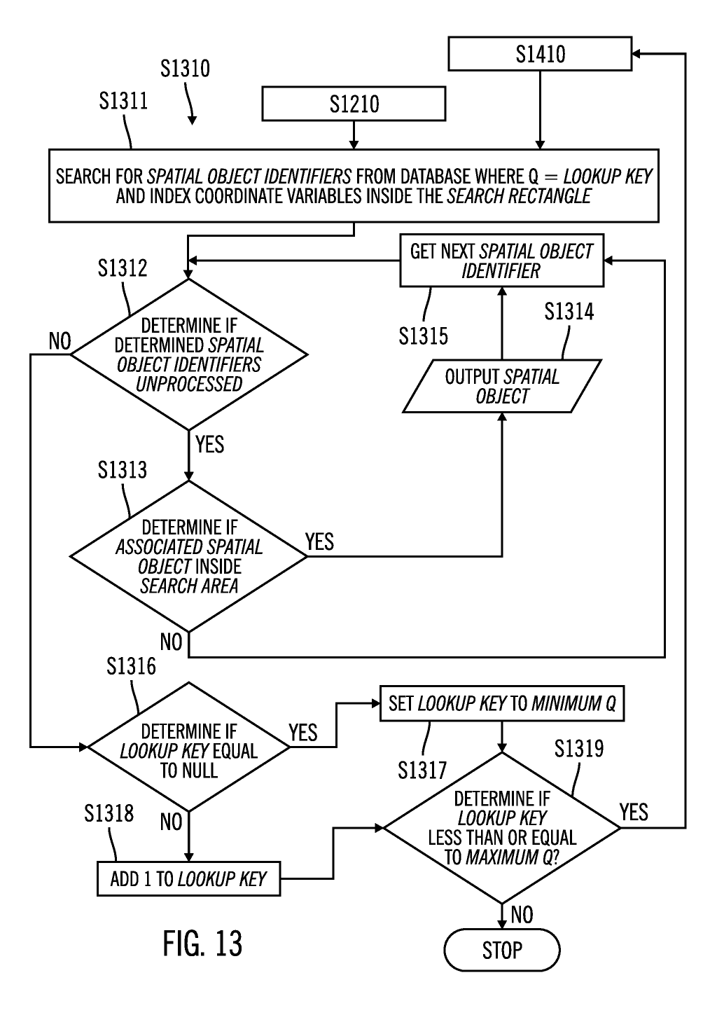

Operation S1214 transfers operation to operation S1310 shown in FIG. 13. Operation S1310 includes executable code for directing CPU 304 to perform search and output operations. Operation S1311 searches the database 312 for spatial object identifiers where the Q value equals the lookup key value and index coordinate variables are inside the search rectangle. Spatial identifiers meeting these criteria are saved to memory 308 and control transfers to operation S1312.

Operation S1312 determines if there are any saved spatial identifiers from operation S1311 remaining to be processed. If there are, operation S1313 accesses the database 312 to determine if the boundary of the spatial object associated with a selected unprocessed spatial object identifier intersects the search area. If it does not, control transfers directly from operation S1313 to operation S1315. If it does intersect, control transfers to operation S1314, which outputs that spatial object as a final search result to memory 308. Final search results can be further processed according to requests 324 or produced to the user interface 322.

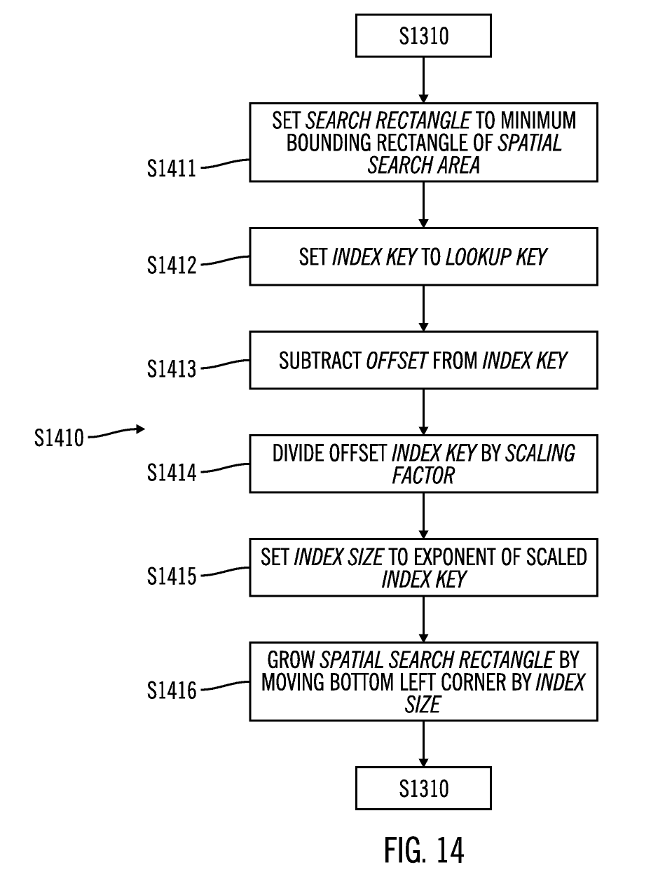

Operation S1315 then accesses memory 308 for the next unprocessed spatial object identifier from operation S1311. Output operations continue until operation S1312 determines that there are no more unprocessed spatial identifiers in memory 308. When there are no more unprocessed spatial identifiers, operation transfers to operation S1316 to determine if the lookup key value is equal to null. If it is, operation S1317 sets the lookup key value to the minimum Q value. If it is not null, operation S1318 increases the lookup key value by 1. In either case, operation then transfers to operation S1319. Operation S1319 determines if the lookup key value is less than or equal to the maximum Q value. If it is not, operation S1310 terminates. Otherwise, operation is transferred to operation S1410 shown in FIG. 14. Following completion of operation S1410, control returns to operation S1310.

Operation S1410 includes executable code for directing CPU 304 to increase the size of the search rectangle based on the lookup key value for Q. Operation S1411 sets the search rectangle dimensions as the minimum bounding rectangle for the search area. Operation S1412 sets an index key equal to the lookup key value and passes the index key value to operation S1413. Operation S1413 subtracts the offset 913 from the index key and passes an offset index key to Operation S1414. Operation S1414 divides the offset index key by the scaling factor 912 and passes the scaled index key to operation S1415. Operation S1415 sets an index size to equal the exponent of the scaled index key and passes the index size to operation S1416.

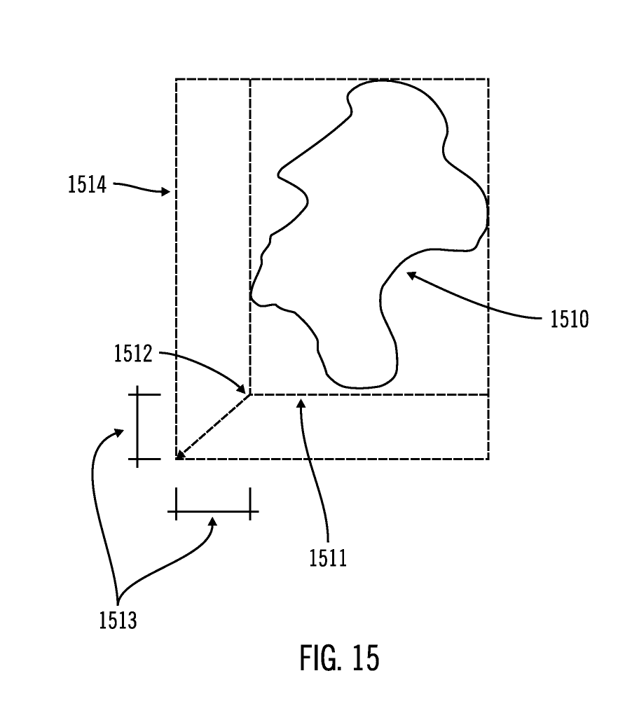

Operation S1416 increases the dimensions of the search rectangle by decreasing its minimum coordinate values by the index size value. As shown in FIG. 15, in one embodiment suitable for a two dimensional search area 1510, decreasing the minimum coordinate values by the index value has the effect of enlarging the search rectangle size 1511 set in operation S1411 by moving the bottom left corner 1512 of the search rectangle in the negative direction according to the index size 1513 to create an enlarged search rectangle 1514. Thus, the search rectangle is derived by the spatial data system by growing the search area minimum bounding rectangle by a size determined by the lookup key.

The new search rectangle dimensions resulting from operation S1410 are then passed back to operation S1310 to perform search and output operations using the new search rectangle dimensions until the maximum Q has been processed and operation S1310 terminates.

The following table exemplifies the performance comparison of searches between a prior art SQL Server index application and a preferred embodiment of the spatial data system when applied to real estate parcel data within a specified search area. For every search area, the preferred embodiment of the spatial data system is faster than the prior art SQL Server index application.

| | | | | SQL Server | | Spatial Index | |
|---|---|---|---|---|---|---|---|
| xmin | Ymin | xmax | ymax | Parcels (search time) | | Parcels (search time) | |
| 144.76 | −37.83 | 144.77 | −37.82 | 7 | (<second) | 7 | (<second) |
| 144.86 | −37.83 | 144.87 | −37.82 | 225 | (1 second) | 225 | (<second) |
| 144.96 | −37.83 | 144.97 | −37.82 | 1888 | (5 seconds) | 1888 | (<second) |
| 145.06 | −37.83 | 145.07 | −37.82 | 1011 | (3 seconds) | 1011 | (<second) |
| 145.06 | −37.84 | 145.08 | −37.82 | 4558 | (6 seconds) | 4558 | (<second) |
| 144.96 | −37.84 | 144.98 | −37.82 | 6619 | (9 seconds) | 6619 | (<second) |
| 144.95 | −37.85 | 145.00 | −37.80 | 67702 | (11 seconds) | 67702 | (2 seconds) |

In accordance with the invention, the index of spatial indexes can be extended to have additional columns. For example, in another embodiment of the spatial data system, the following spatial index variable in SQL code is added to the spatial index to allow full processing of the “where” clause of a query with index scans without needing to fetch data:
CREATE INDEX IX_PROPERTY_QEXTENT ON PROPERTY (SHAPE_Q, SHAPE_XMIN, SHAPE_YMIN, SHAPE_XMAX, SHAPE_YMAX);

The spatial data system can be applied to a wide range of computing and database platforms with minimal specific adaptation to the platforms. This creates significant opportunities to use and query spatial data on platforms previously considered unsuitable, especially for very large datasets.

It will be apparent to those skilled in the art that changes and modifications may be made in the embodiments illustrated and described, without departing from the spirit and the scope of the invention. Thus, the invention is not to be limited to the particular forms herein shown and described except insofar as indicated by the scope of the appended claim.

The invention claimed is:

1. A method of directing a data processing system to manage one or more spatial object identifiers stored in a database, the spatial object identifiers each associated with a spatial object produced on a user interface, the method comprising:
accessing the database;
for each spatial object, performing:
creating a spatial index with one or more index coordinate variables and one or more index dimension variables wherein the index coordinate variables define a single point spatially related to the spatial object and the index dimension variables define a bounding shape of dimensions sufficient to surround the spatial object when the index dimension variables are applied to the single point;
generating entries in one or more indices of the database associating the spatial index with the spatial object identifier identifying the associated spatial object;
receiving a search area;
searching, by the data processing system, the indices to determine the spatial indexes defining the bounding shapes that intersect the search area when the index dimension variables are applied to the single point;
determining the spatial object identifiers associated with the determined spatial indexes; and
producing on the user interface the spatial objects associated with the determined spatial object identifiers.

2. The method of claim 1 wherein the index coordinate variables correspond to one or more extreme variable values for the spatial object.

3. The method of claim 1 wherein the single point is at the geometric center of the spatial object.

4. The method of claim 1 wherein the index dimension variables are one or more vectors of a magnitude equal to a largest dimension of the spatial object.

5. The method of claim 1 wherein the index dimension variables include one or more radii.

6. The method of claim 1 further providing, in the spatial index creation operation, a scalar value function means for optimizing the index dimension variables.

7. The method of claim 6 wherein the scalar value function means includes rounding a largest dimension value to the next largest integer.

8. The method of claim 6 wherein the scalar value function means includes taking the logarithm of a largest dimension value.

9. The method of claim 6 wherein the scalar value function means includes a scaling factor predetermined based on the database content.

10. The method of claim 6 wherein the scalar value function means includes a scaling factor predetermined based on the data processing system capacity.

11. The method of claim 6 wherein the scalar value function means is the same for all geometry types.

12. The method of claim 1 further comprising:
creating one or more range identifiers each associated with a predetermined range of largest dimensions for spatial objects;
generating entries in the indices associating the range identifiers with predetermined bounding shapes;
in the spatial index creation operation, further performing:
determining a largest dimension for the spatial object;
searching, by the data processing system, the indices to find the range identifier associated with the predetermined range of largest dimensions that include the determined largest dimension; and
assigning the found range identifier as the index dimension variable for the spatial object.

13. The method of claim 1 wherein applying the index dimension variables to the single point resizes a predetermined bounding shape according to the index dimension variables.

14. The method of claim 1 wherein one or more axes of the spatial object define dimensions other than distance.

15. The method of claim 1 further comprising:
grouping the spatial object identifiers based on predetermined ranges of the index dimension variables to define one or more grouped spatial object ranges; and
selecting an area scale of the user interface based on the grouped spatial object ranges intersecting the search area.

16. The method of claim 1 further comprising:
grouping the spatial object identifiers based on predetermined ranges of the index dimension variables to define one or more grouped spatial object ranges; and
partitioning database operations amongst a plurality of processors in the data processing system based on the grouped spatial object ranges.

17. The method of claim 1 further comprising:
grouping the spatial object identifiers based on predetermined ranges of the index dimension variables to define one or more grouped spatial object ranges; and
partitioning the database amongst a plurality of computer usable memory devices in the data processing system based on the grouped spatial object ranges.

18. The method of claim 1 wherein the data processing system is selected from the group consisting of a mobile device, an embedded device, a desktop device, a server, a mainframe computer, or networked combinations thereof.

19. The method of claim 1 wherein the indices index one or more database tables wherein each database table optionally includes a variety of spatial data types.

20. A data processing system for managing one or more spatial object identifiers stored in a database, the spatial object identifiers each associated with a spatial object produced on a user interface, the data processing system comprising:
a central processing unit;
a computer usable memory including code executed by the central processing unit to perform operations, the operations comprising:
accessing the database;
for each spatial object, performing:
creating a spatial index with one or more index coordinate variables and one or more index dimension variables wherein the index coordinate variables define a single point spatially related to the spatial object and the index dimension variables define a bounding shape of dimensions sufficient to surround the spatial object when the index dimension variables are applied to the single point;
generating entries in one or more indices of the database associating the spatial index with the spatial object identifier identifying the associated spatial object;
receiving a search area;
searching, by the data processing system, the indices to determine the spatial indexes defining the bounding shapes that intersect the search area when the index dimension variables are applied to the single point;
determining the spatial object identifiers associated with the determined spatial indexes; and
producing on the user interface the spatial objects associated with the determined spatial object identifiers.

21. The data processing system of claim 20 wherein the index coordinate variables correspond to one or more extreme variable values for the spatial object.

22. The data processing system of claim 20 wherein the single point is at the geometric center of the spatial object.

23. The data processing system of claim 20 wherein the index dimension variables are one or more vectors of a magnitude equal to a largest dimension of the spatial object.

24. The data processing system of claim 20 wherein the index dimension variables include one or more radii.

25. The data processing system of claim 20 wherein the operations further comprise:
in the spatial index creation operation, providing a scalar value function means for optimizing the index dimension variables.

26. The data processing system of claim 25 wherein the scalar value function means includes rounding a largest dimension value to the next largest integer.

27. The data processing system of claim 25 wherein the scalar value function means includes taking the logarithm of a largest dimension value.

28. The data processing system of claim 25 wherein the scalar value function means includes a scaling factor predetermined based on the database content.

29. The data processing system of claim 25 wherein the scalar value function means includes a scaling factor predetermined based on the data processing system capacity.

30. The data processing system of claim 25 wherein the scalar value function means is the same for all geometry types.

31. The data processing system of claim 20 wherein the operations further comprise:
creating one or more range identifiers each associated with a predetermined range of largest dimensions for spatial objects;
generating entries in the indices associating the range identifiers with predetermined bounding shapes;
in the spatial index creation operation, further performing:
determining a largest dimension for the spatial object;
searching, by the data processing system, the indices to find the range identifier associated with the predetermined range of largest dimensions that include the determined largest dimension; and
assigning the found range identifier as the index dimension variable for the spatial object.

32. The data processing system of claim 20 wherein applying the index dimension variables to the single point resizes a predetermined bounding shape according to the index dimension variables.

33. The data processing system of claim 20 wherein one or more axes of the spatial object define dimensions other than distance.

34. The data processing system of claim 20 wherein the operations further comprise:
grouping the spatial object identifiers based on predetermined ranges of the index dimension variables to define one or more grouped spatial object ranges; and
selecting an area scale of the user interface based on the grouped spatial object ranges intersecting the search area.

35. The data processing system of claim 20 further comprising:
one or more processors operatively linked to the central processing unit;
additional code on the computer usable memory executed by the central processing unit to perform operations, the operations comprising:
grouping the spatial object identifiers based on predetermined ranges of the index dimension variables to define one or more grouped spatial object ranges; and
partitioning database operations amongst the processors and the central processing unit based on the grouped spatial object ranges.

36. The data processing system of claim 20 wherein the operations further comprise:
grouping the spatial object identifiers based on predetermined ranges of the index dimension variables to define one or more grouped spatial object ranges; and
partitioning the database within the computer usable memory based on the grouped spatial object ranges.

37. The data processing system of claim 20 wherein the data processing system is selected from the group consisting of a mobile device, an embedded device, a desktop device, a server, a mainframe computer, or networked combinations thereof.

38. The data processing system of claim 20 wherein the indices index one or more database tables wherein each database table optionally includes a variety of spatial data types.

39. An article of manufacture having a computer usable memory embodying computer usable instructions executable by a data processing system, the computer usable instructions for directing the data processing system to manage one or more spatial object identifiers stored in a database, the spatial object identifiers each associated with a spatial object produced on a user interface, wherein the executed computer usable instructions perform operations, the operations comprising:
accessing the database;
for each spatial object, performing:
creating a spatial index with one or more index coordinate variables and one or more index dimension variables wherein the index coordinate variables define a single point spatially related to the spatial object and the index dimension variables define a bounding shape of dimensions sufficient to surround the spatial object when the index dimension variables are applied to the single point;
generating entries in one or more indices of the database associating the spatial index with the spatial object identifier identifying the associated spatial object;
receiving a search area;
searching, by the data processing system, the indices to determine the spatial indexes defining the bounding shapes that intersect the search area when the index dimension variables are applied to the single point;
determining the spatial object identifiers associated with the determined spatial indexes; and
producing on the user interface the spatial objects associated with the determined spatial object identifiers.

40. The article of manufacture of claim 39 wherein the index coordinate variables correspond to one or more extreme variable values for the spatial object.

41. The article of manufacture of claim 39 wherein the single point is at the geometric center of the spatial object.

42. The article of manufacture of claim 39 wherein the index dimension variables are one or more vectors of a magnitude equal to a largest dimension of the spatial object.

43. The article of manufacture of claim 39 wherein the index dimension variables include one or more radii.

44. The article of manufacture of claim 39 wherein the operations further comprise:
in the spatial index creation operation, providing a scalar value function means for optimizing the index dimension variables.

45. The article of manufacture of claim 44 wherein the scalar value function means includes rounding a largest dimension value to the next largest integer.

46. The article of manufacture of claim 44 wherein the scalar value function means includes taking the logarithm of a largest dimension value.

47. The article of manufacture of claim 44 wherein the scalar value function means includes a scaling factor predetermined based on the database content.

48. The article of manufacture of claim 44 wherein the scalar value function means includes a scaling factor predetermined based on the data processing system capacity.

49. The article of manufacture of claim 44 wherein the scalar value function means is the same for all geometry types.

51. The article of manufacture of claim 39 wherein the operations further comprise:
creating one or more range identifiers each associated with a predetermined range of largest dimensions for spatial objects;
generating entries in the indices associating the range identifiers with predetermined bounding shapes;
in the spatial index creation operation, further performing:
determining a largest dimension for the spatial object;
searching, by the data processing system, the indices to find the range identifier associated with the predetermined range of largest dimensions that include the determined largest dimension; and
assigning the found range identifier as the index dimension variable for the spatial object.

52. The article of manufacture of claim 39 wherein applying the index dimension variables to the single point resizes a predetermined bounding shape according to the index dimension variables.

53. The article of manufacture of claim 39 wherein one or more axes of the spatial object define dimensions other than distance.

54. The article of manufacture of claim 39 wherein the operations further comprise:
grouping the spatial object identifiers based on predetermined ranges of the index dimension variables to define one or more grouped spatial object ranges; and
selecting an area scale of the user interface based on the grouped spatial object ranges intersecting the search area.

55. The article of manufacture of claim 39 wherein the operations further comprise:
grouping the spatial object identifiers based on predetermined ranges of the index dimension variables to define one or more grouped spatial object ranges; and
partitioning database operations amongst a plurality of processors in the data processing system based on the grouped spatial object ranges.

56. The article of manufacture of claim 39 wherein the operations further comprise:
grouping the spatial object identifiers based on predetermined ranges of the index dimension variables to define one or more grouped spatial object ranges; and
partitioning the database amongst a plurality of computer usable memory devices in the data processing system based on the grouped spatial object ranges.

57. The article of manufacture of claim 39 wherein the data processing system is selected from the group consisting of a mobile device, an embedded device, a desktop device, a server, a mainframe computer, or networked combinations thereof.

58. The article of manufacture of claim 39 wherein the indices index one or more database tables wherein each database table optionally includes a variety of spatial data types.
